(19) United States
(12) Patent Application Publication
(10) Pub. No.: US 2025/0294259 A1
(43) Pub. Date: Sep. 18, 2025

(54) MONOTONIC REGULARIZATION FOR ROBUST NEURAL LIGHT ESTIMATION

(71) Applicant: QUALCOMM Incorporated, San Diego, CA (US)

(72) Inventors: Xuepeng SHI, Amsterdam (NL); Shihao WU, Amsterdam (NL); Oleksandr BAILO, Amsterdam (NL); Georgi DIKOV, Amsterdam (NL); Gerhard REITMAYR, Del Mar, CA (US); Mohsen GHAFOORIAN, Diemen (NL)

(21) Appl. No.: 18/602,810

(22) Filed: Mar. 12, 2024

(51) Int. Cl. H04N 23/71

(52) U.S. Cl. CPC H04N 23/71

(57) ABSTRACT

Disclosed are systems and techniques for light estimation. For example, a computing device can determine, using a first neural network, first intensities of the scene based on camera rays for an image of the scene. The computing device can determine, using one or more second neural networks each comprising a camera response function, second intensities of the scene based on the first intensities of the scene. The one or more second neural networks are trained to learn the camera response function based on a regularization loss.

### FIELD

The present disclosure generally relates to light estimation. For example, aspects of the present disclosure relate to monotonic regularization for robust neural light estimation.

### BACKGROUND

Image sensors are commonly integrated into a wide array of electronic devices such as cameras, mobile phones, autonomous systems (e.g., autonomous drones, cars, robots, etc.), smart wearables, extended reality (e.g., augmented reality, virtual reality, mixed reality) devices, and many other devices. The image sensors allow users to light signals and images from any electronic device equipped with an image sensor. The light signals and images can be captured for recreational use, professional photography, surveillance, and automation, among other applications.

In some cases, the light signals and image data captured by an image sensor can be analyzed to identify certain characteristics about the image data and/or the scene captured by the image data, which can then be used to modify the captured image data or perform various tasks. For example, light signals and/or image data can be analyzed to perform light estimation of a scene. Light estimation may include determining information about one or more light sources illuminating the scene, such as the number, type, and/or location of the light sources, as well as the intensity, color temperature, and/or other ambient qualities of the light emitted by the light sources. In some cases, light estimation can be implemented within extended reality systems to facilitate immersive blending of virtual content with real-world content visible through an extended reality display (e.g., a head-mounted display). Light estimation can be useful in various other applications, such as applications that involve performing image processing operations or algorithms (e.g., auto-white balance algorithms).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for light estimation are provided. According to at least one example, an apparatus is provided for light estimation of a scene. The apparatus includes at least one memory and at least one processor coupled to the at least one memory and configured to: determine, using a first neural network, first intensities of the scene based on camera rays for an image of the scene; and determine, using one or more second neural networks each comprising a camera response function, second intensities of the scene based on the first intensities of the scene, wherein the one or more second neural networks are trained to learn the camera response function based on a regularization loss.

In another illustrative example, a method is provided for light estimation of a scene. The method includes: determining, using a first neural network, first intensities of the scene based on camera rays for an image of the scene; and determining, using one or more second neural networks each comprising a camera response function, second intensities of the scene based on the first intensities of the scene, wherein the one or more second neural networks are trained to learn the camera response function based on a regularization loss.

In another illustrative example, a non-transitory computer-readable medium is provided having stored thereon instructions that, when executed by at least one processor, cause the at least one processor to: determine, using a first neural network, first intensities of a scene based on camera rays for an image of the scene; and determine, using one or more second neural networks each comprising a camera response function, second intensities of the scene based on the first intensities of the scene, wherein the one or more second neural networks are trained to learn the camera response function based on a regularization loss.

In another illustrative example, an apparatus is provided for light estimation of a scene. The apparatus includes: means for determining, using a first neural network, first intensities of the scene based on camera rays for an image of the scene; and means for determining, using one or more second neural networks each comprising a camera response function, second intensities of the scene based on the first intensities of the scene, wherein the one or more second neural networks are trained to learn the camera response function based on a regularization loss.

Aspects generally include a method, apparatus, system, computer program product, non-transitory computer-readable medium, user device, user equipment, wireless communication device, and/or processing system as substantially described with reference to and as illustrated by the drawings and specification.

In some aspects, each of the apparatuses described herein is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, each apparatus can include an image sensor (e.g., a camera) or multiple image sensors (e.g., multiple cameras) for capturing one or more images. In some aspects, each apparatus can include a display or multiple displays for displaying one or more images, notifications, and/or other displayable data. In some aspects, each apparatus can include one or more speakers, one or more light-emitting devices, one or more microphones, and/or other output device(s). In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example architecture of a light estimation system in accordance with some examples.

FIG. 2A, FIG. 2B, and FIG. 2C are illustrations of example virtual content generated based on light estimation, in accordance with some examples.

FIG. 3 is a block diagram of an example system for light estimation, in accordance with some examples.

FIG. 4 is a block diagram of an example system for light estimation, in accordance with some examples.

FIG. 5 is a diagram illustrating an example of a deep learning neural network, in accordance with some examples.

FIG. 6 is a diagram illustrating an example of a convolutional neural network, in accordance with some examples.

FIG. 7 is a diagram illustrating an example of a process for neural light estimation, in accordance with some examples.

FIG. 8 is a diagram illustrating an example of images for the process for neural light estimation of FIG. 7, in accordance with some examples.

FIG. 9 is a table illustrating an example of characteristics for different types of datasets, in accordance with some examples.

FIG. 10 is a graph illustrating an example of an incorrect camera response function, which can result when using the process for neural light estimation of FIG. 7, in accordance with some examples.

FIG. 11 is a diagram illustrating an example of a degenerate HDR image that may be produced by the process for neural light estimation of FIG. 7, in accordance with some examples.

FIG. 12 is a diagram illustrating an example of a system for monotonic regularization for robust neural light estimation, in accordance with some examples.

FIG. 13 is a diagram illustrating graphs showing examples of comparisons of camera response functions and training losses, respectively, when applying (and not applying) a regularization loss for neural light estimation, in accordance with some examples.

FIG. 14 is a diagram illustrating an example of a comparison of HDR images when applying (and not applying) a regularization loss for neural light estimation, in accordance with some examples.

FIG. 15 is a diagram illustrating graphs showing an example of a comparison of predicted light intensities using neural light estimation with a regulation loss and measured light intensities measured by a luminance meter, in accordance with some examples.

FIG. 16 is a flow diagram illustrating an example of a process for light estimation, in accordance with some examples.

FIG. 17 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, light estimation can include determining lighting parameters of one or more light sources illuminating a scene. For instance, light estimation can include determining the number, type, and/or location of the light sources. Further, light estimation can include determining the intensity, color temperature, and/or other ambient qualities of the light emitted by the light sources. In some cases, light estimation can be implemented within extended reality systems to facilitate immersive blending of virtual content with real-world content visible through an extended reality display (e.g., a head-mounted display). Light estimation can be useful in various other applications, such as applications that involve performing image processing operations or algorithms (e.g., auto-white balance algorithms, auto-exposure algorithms, auto-focus algorithms, among others).

Light estimation is an important perception feature in XR applications, which can be used to render virtual objects realistically. It is desirable to learn the intensity and location of light sources in a self-supervised manner without human annotation of the light sources. However, current state of-the-art methods, such as the high dynamic range neural radiance fields (HDR-NeRF) method, are observed to show divergent behavior depending on the initialization conditions, often resulting in degenerate solutions where the learned camera response function (CRF) is incorrect, and the light sources cannot be identified.

As such, improved systems and techniques that provide for robust light estimation can be beneficial.

In one or more aspects, systems, apparatuses, processes (also referred to as methods), and computer-readable media (collectively referred to herein as “systems and techniques”) are described herein for providing monotonic regularization for robust neural light estimation. In one or more examples, the systems and techniques impose a monotonic physical prior to the CRF prediction of self-supervised light estimation methods. This is achieved by formulating the physical prior as a regularization loss (Lreg) during the training. With the regularization loss, the network (e.g., neural network) can be encouraged to learn a monotonically increasing CRF. Based on this, a robust self-supervised light estimation system can be implemented. The regularization loss can enable robust and scalable neural light estimation, even for diverse and challenging datasets, and can also be generalized for use with different camera devices. As such, the intensity and location of the light sources can be obtained from low dynamic range (LDR) images without the need for human annotations.

In one or more aspects, during operation of the systems and techniques for light estimation of a scene, a first neural network can determine first intensities (e.g., high dynamic range (HDR) intensities) of the scene based on camera rays for an image of the scene. One or more second neural networks, each including a camera response function (CRF), can determine second intensities (e.g., low dynamic range (LDR) intensities) of the scene based on the first intensities (e.g., HDR intensities) of the scene. In one or more examples, the one or more second neural networks can be trained to learn the camera response function by applying a regularization loss (Lreg).

In one or more examples, as a result of the training of the one or more second neural networks, the regularization loss can force the camera response function to be monotonically increasing. In some examples, a camera ray can include a ray origin and a ray direction. In one or more examples, the first intensities (e.g., HDR intensities) can have a higher dynamic range than the second intensities (e.g., LDR intensities). In some examples, determining, by the one or more second neural networks, the second intensities can be further based on an exposure of the image. In one or more examples, the exposure can include a product of exposure time and gain of the image. In some examples, the first neural network can include a radiance field model. In one or more examples, the first neural network can be trained to learn the radiance field model by applying a plurality of multi-view images with the second intensities.

In one or more aspects, the systems and techniques have a number of benefits. In one or more examples, the systems and techniques can enable robust and accurate neural light estimation for diverse and challenging datasets. In some examples, the systems and techniques can be generalized for use with different cameras. In one or more examples, the systems and techniques do not require any additional computational cost or parameters at the model inference. In some examples, the systems and techniques can obtain the intensity and location of light sources from LDR images without the need for human annotations.

Additional aspects of the present disclosure are described in more detail below.

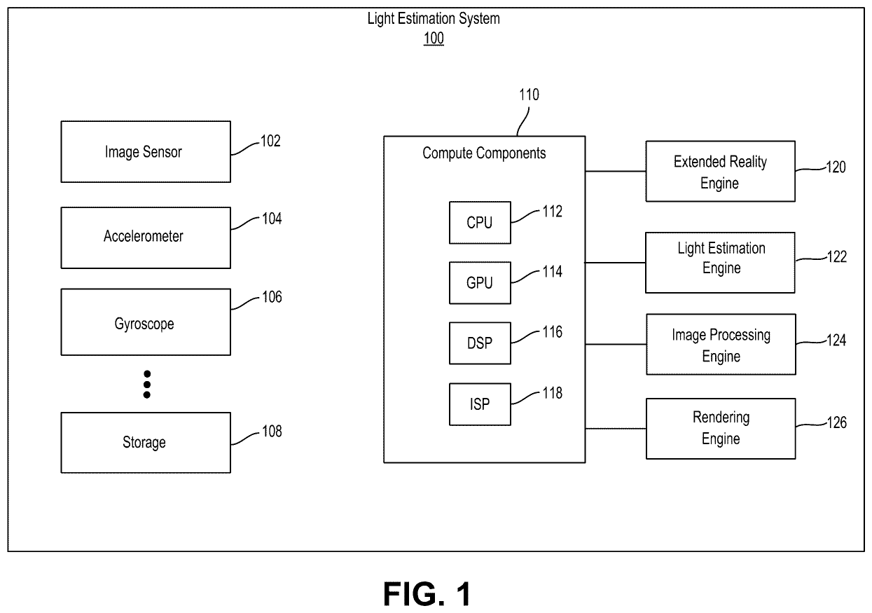

FIG. 1 is a diagram illustrating an example light estimation system 100, in accordance with some aspects of the disclosure. The light estimation system 100 can be part of, or implemented by, a single computing device or multiple computing devices. In some cases, the light estimation system 100 can be part of, or implemented by, an XR system or device. For instance, the light estimation system 100 can run (or execute) XR applications and implement XR operations. The XR system or device that includes and/or implements the light estimation system 100 can be an XR head-mounted display (HMD) device (e.g., a virtual reality (VR) headset, an augmented reality (AR) headset, or an mixed reality (MR) headset), XR glasses (e.g., AR glasses), among other XR systems or devices. In some examples, the light estimation system 100 can be part of, or implemented by, any other device or system, such as a camera system (e.g., a digital camera, an IP camera, a video camera, a security camera, etc.), a telephone system (e.g., a smartphone, a cellular telephone, a conferencing system, etc.), a desktop computer, a laptop or notebook computer, a tablet computer, a set-top box, a network-connected television (or so-called “smart” television), a display device, a gaming console, a video streaming device, an Internet-of-Things (IoT) device, a vehicle (or computing device of a vehicle), and/or any other suitable electronic device(s).

In some examples, the light estimation system 100 can perform tracking and localization, mapping of the physical world (e.g., a scene), and positioning and rendering of virtual content on a display (e.g., a screen, visible plane/region, and/or other display) as part of an XR experience. For example, the light estimation system 100 can generate a map (e.g., 3D map) of a scene in the physical world, track a pose (e.g., location and position) of the light estimation system 100 relative to the scene (e.g., relative to the 3D map of the scene), position and/or anchor virtual content in a specific location(s) on the map of the scene, and render the virtual content on the display. The light estimation system 100 can render the virtual content on the display such that the virtual content appears to be at a location in the scene corresponding to the specific location on the map of the scene where the virtual content is positioned and/or anchored. In some examples, the display can include a glass, a screen, a lens, and/or other display mechanism that allows a user to see the real-world environment and also allows XR content to be displayed thereon.

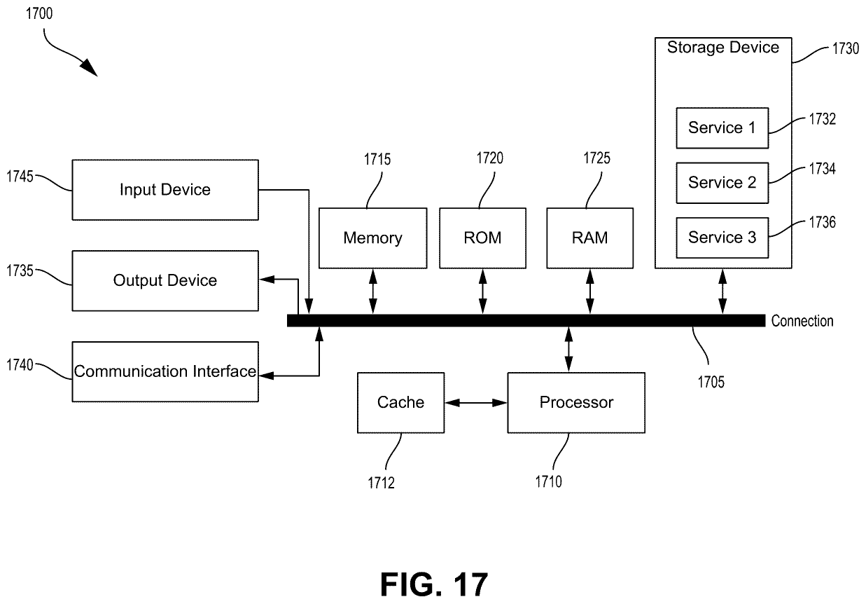

As shown in FIG. 1, the light estimation system 100 can include one or more image sensors 102, an accelerometer 104, a gyroscope 106, storage 108, compute components 110, an XR engine 120, a light estimation engine 122, an image processing engine 124, and a rendering engine 126. It should be noted that the components 102-126 shown in FIG. 1 are non-limiting examples provided for illustrative and explanation purposes, and other examples can include more, less, or different components than those shown in FIG. 1. For example, in some cases, the light estimation system 100 can include one or more other sensors (e.g., one or more inertial measurement units (IMUs), radars, light detection and ranging (LIDAR) sensors, audio sensors, etc.), one or more display devices, one more other processing engines, one or more other hardware components, and/or one or more other software and/or hardware components that are not shown in FIG. 1. An example architecture and example hardware components that can be implemented by the light estimation system 100 are further described below with respect to FIG. 17.

For simplicity and explanation purposes, the one or more image sensors 102 will be referenced herein as an image sensor 102 (e.g., in singular form). However, one of ordinary skill in the art will recognize that the light estimation system 100 can include a single image sensor or multiple image sensors. Also, references to any of the components (e.g., 102-126) of the light estimation system 100 in the singular or plural form should not be interpreted as limiting the number of such components implemented by the light estimation system 100 to one or more than one. For example, references to an accelerometer 104 in the singular form should not be interpreted as limiting the number of accelerometers implemented by the light estimation system 100 to one. One of ordinary skill in the art will recognize that, for any of the components 102-126 shown in FIG. 1, the light estimation system 100 can include only one of such component(s) or more than one of such component(s).

The light estimation system 100 can include or be in communication with (wired or wirelessly) an input device. The input device can include any suitable input device, such as a touchscreen, a pen or other pointer device, a keyboard, a mouse a button or key, a microphone for receiving voice commands, a gesture input device for receiving gesture commands, any combination thereof, and/or other input device. In some cases, the image sensor 102 can capture images that can be processed for interpreting gesture commands.

The light estimation system 100 can be part of, or implemented by, a single computing device or multiple computing devices. In some examples, the light estimation system 100 can be part of an electronic device (or devices) such as an extended reality head-mounted display (HMD) device, extended reality glasses (e.g., augmented reality or AR glasses), a camera system (e.g., a digital camera, an IP camera, a video camera, a security camera, etc.), a telephone system (e.g., a smartphone, a cellular telephone, a conferencing system, etc.), a desktop computer, a laptop or notebook computer, a tablet computer, a set-top box, a smart television, a display device, a gaming console, a video streaming device, an Internet-of-Things (IoT) device, and/or any other suitable electronic device(s).

In some implementations, the one or more image sensors 102, the accelerometer 104, the gyroscope 106, storage 108, compute components 110, the XR engine 120, the light estimation engine 122, the image processing engine 124, and the rendering engine 126 can be part of the same computing device. For example, in some cases, the one or more image sensors 102, the accelerometer 104, the gyroscope 106, storage 108, compute components 110, the XR engine 120, the light estimation engine 122, image processing engine 124, and rendering engine 126 can be integrated into an HMD, extended reality glasses, smartphone, laptop, tablet computer, gaming system, and/or any other computing device. However, in some implementations, the one or more image sensors 102, the accelerometer 104, the gyroscope 106, storage 108, compute components 110, the XR engine 120, the light estimation engine 122, the image processing engine 124, and the rendering engine 126 can be part of two or more separate computing devices. For example, in some cases, some of the components 102-126 can be part of, or implemented by, one computing device and the remaining components can be part of, or implemented by, one or more other computing devices.

The storage 108 can be any storage device(s) for storing data. Moreover, the storage 108 can store data from any of the components of the light estimation system 100. For example, the storage 108 can store data from the image sensor 102 (e.g., image or video data), data from the accelerometer 104 (e.g., measurements), data from the gyroscope 106 (e.g., measurements), data from the compute components 110 (e.g., processing parameters, preferences, virtual content, rendering content, scene maps, tracking and localization data, object detection data, privacy data, XR application data, face recognition data, occlusion data, etc.), data from the XR engine 120, data from the a light estimation engine 122, data from the image processing engine 124, and/or data from the rendering engine 126 (e.g., output frames). In some examples, the storage 108 can include a buffer for storing frames for processing by the compute components 110.

The one or more compute components 110 can include a central processing unit (CPU) 112, a graphics processing unit (GPU) 114, a digital signal processor (DSP) 116, and/or an image signal processor (ISP) 118. The compute components 110 can perform various operations such as image enhancement, computer vision, graphics rendering, extended reality (e.g., tracking, localization, pose estimation, mapping, content anchoring, content rendering, etc.), image/video processing, sensor processing, recognition (e.g., text recognition, facial recognition, object recognition, feature recognition, tracking or pattern recognition, scene recognition, occlusion detection, etc.), machine learning, filtering, and any of the various operations described herein. In this example, the compute components 110 implement the XR engine 120, the light estimation engine 122, the image processing engine 124, and the rendering engine 126. In other examples, the compute components 110 can also implement one or more other processing engines.

The image sensor 102 can include any image and/or video sensors or capturing devices. In some examples, the image sensor 102 can be part of a multiple-camera assembly, such as a dual-camera assembly. The image sensor 102 can capture image and/or video content (e.g., raw image and/or video data), which can then be processed by the compute components 110, the XR engine 120, the light estimation engine 122, the image processing engine 124, and/or the rendering engine 126 as described herein.

In some examples, the image sensor 102 can capture image data and can generate frames based on the image data and/or can provide the image data or frames to the XR engine 120, the light estimation engine 122, the image processing engine 124, and/or the rendering engine 126 for processing. A frame can include a video frame of a video sequence or a still image. A frame can include a pixel array representing a scene. For example, a frame can be a red-green-blue (RGB) frame having red, green, and blue color components per pixel; a luma, chroma-red, chroma-blue (YCbCr) frame having a luma component and two chroma (color) components (chroma-red and chroma-blue) per pixel; or any other suitable type of color or monochrome picture.

In some cases, the image sensor 102 (and/or other image sensor or camera of the light estimation system 100) can be configured to also capture depth information. For example, in some implementations, the image sensor 102 (and/or other camera) can include an RGB-depth (RGB-D) camera. In some cases, the light estimation system 100 can include one or more depth sensors (not shown) that are separate from the image sensor 102 (and/or other camera) and that can capture depth information. For instance, such a depth sensor can obtain depth information independently from the image sensor 102. In some examples, a depth sensor can be physically installed in a same general location the image sensor 102, but may operate at a different frequency or frame rate from the image sensor 102. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

As noted above, in some cases, the light estimation system 100 can also include one or more sensors (not shown) other than the image sensor 102. For instance, the one or more sensors can include one or more accelerometers (e.g., accelerometer 104), one or more gyroscopes (e.g., gyroscope 106), and/or other sensors. The one or more sensors can provide velocity, orientation, and/or other position-related information to the compute components 110. For example, the accelerometer 104 can detect acceleration by the light estimation system 100 and can generate acceleration measurements based on the detected acceleration. In some cases, the accelerometer 104 can provide one or more translational vectors (e.g., up/down, left/right, forward/back) that can be used for determining a position or pose of the light estimation system 100. The gyroscope 106 can detect and measure the orientation and angular velocity of the light estimation system 100. For example, the gyroscope 106 can be used to measure the pitch, roll, and yaw of the light estimation system 100. In some cases, the gyroscope 106 can provide one or more rotational vectors (e.g., pitch, yaw, roll). In some examples, the image sensor 102 and/or the XR engine 120 can use measurements obtained by the accelerometer 104 (e.g., one or more translational vectors) and/or the gyroscope 106 (e.g., one or more rotational vectors) to calculate the pose of the light estimation system 100. As previously noted, in other examples, the light estimation system 100 can also include other sensors, such as an inertial measurement unit (IMU), a magnetometer, a machine vision sensor, a smart scene sensor, a speech recognition sensor, an impact sensor, a shock sensor, a position sensor, a tilt sensor, etc.

In some cases, the one or more sensors can include at least one IMU. An IMU is an electronic device that measures the specific force, angular rate, and/or the orientation of the light estimation system 100, using a combination of one or more accelerometers, one or more gyroscopes, and/or one or more magnetometers. In some examples, the one or more sensors can output measured information associated with the capture of an image captured by the image sensor 102 (and/or other camera of the light estimation system 100) and/or depth information obtained using one or more depth sensors of the light estimation system 100.

The output of one or more sensors (e.g., the accelerometer 104, the gyroscope 106, one or more IMUs, and/or other sensors) can be used by the extended reality engine 120 to determine a pose of the light estimation system 100 (also referred to as the head pose) and/or the pose of the image sensor 102 (or other camera of the light estimation system 100). In some cases, the pose of the light estimation system 100 and the pose of the image sensor 102 (or other camera) can be the same. The pose of image sensor 102 refers to the position and orientation of the image sensor 102 relative to a frame of reference. In some implementations, the camera pose can be determined for 6-Degrees Of Freedom (6DOF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference).

In some cases, a device tracker (not shown) can use the measurements from the one or more sensors and image data from the image sensor 102 to track a pose (e.g., a 6DOF pose) of the light estimation system 100. For example, the device tracker can fuse visual data (e.g., using a visual tracking solution) from captured image data with inertial measurement data to determine a position and motion of the light estimation system 100 relative to the physical world (e.g., the scene) and a map of the physical world. As described below, in some examples, when tracking the pose of the light estimation system 100, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the light estimation system 100 within the scene and the 3D map of the scene, etc. The 3D map can provide a digital representation of a scene in the real/physical world. In some examples, the 3D map can anchor location-based objects and/or content to real-world coordinates and/or objects. The light estimation system 100 can use a mapped scene (e.g., a scene in the physical world represented by, and/or associated with, a 3D map) to merge the physical and virtual worlds and/or merge virtual content or objects with the physical environment.

In some aspects, the pose of image sensor 102 and/or the light estimation system 100 as a whole can be determined and/or tracked by the compute components 110 using a visual tracking solution based on images captured by the image sensor 102 (and/or other camera of the light estimation system 100). For instance, in some examples, the compute components 110 can perform tracking using computer vision-based tracking, model-based tracking, and/or simultaneous localization and mapping (SLAM) techniques. For instance, the compute components 110 can perform SLAM or can be in communication (wired or wireless) with a SLAM engine (not shown). SLAM refers to a class of techniques where a map of an environment (e.g., a map of an environment being modeled by light estimation system 100) is created while simultaneously tracking the pose of a camera (e.g., image sensor 102) and/or the light estimation system 100 relative to that map. The map can be referred to as a SLAM map, and can be 3D. The SLAM techniques can be performed using color or grayscale image data captured by the image sensor 102 (and/or other camera of the light estimation system 100), and can be used to generate estimates of 6DOF pose measurements of the image sensor 102 and/or the light estimation system 100. Such a SLAM technique configured to perform 6DOF tracking can be referred to as 6DOF SLAM. In some cases, the output of the one or more sensors (e.g., the accelerometer 104, the gyroscope 106, one or more IMUs, and/or other sensors) can be used to estimate, correct, and/or otherwise adjust the estimated pose.

In some cases, the 6DOF SLAM (e.g., 6DOF tracking) can associate features observed from certain input images from the image sensor 102 (and/or other camera) to the SLAM map. For example, 6DOF SLAM can use feature point associations from an input image to determine the pose (position and orientation) of the image sensor 102 and/or light estimation system 100 for the input image. 6DOF mapping can also be performed to update the SLAM map. In some cases, the SLAM map maintained using the 6DOF SLAM can contain 3D feature points triangulated from two or more images. For example, key frames can be selected from input images or a video stream to represent an observed scene. For every key frame, a respective 6DOF camera pose associated with the image can be determined. The pose of the image sensor 102 and/or the light estimation system 100 can be determined by projecting features from the 3D SLAM map into an image or video frame and updating the camera pose from verified 2D-3D correspondences.

In one illustrative example, the compute components 110 can extract feature points from every input image or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The features points in key frames either match (are the same or correspond to) or fail to match the features points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Speed Up Robust Features (SURF), Gradient Location-Orientation histogram (GLOH), Normalized Cross Correlation (NCC), or other suitable technique.

In some cases, the light estimation system 100 can also track the hand and/or fingers of a user to allow the user to interact with and/or control virtual content in a virtual environment. For example, the light estimation system 100 can track a pose and/or movement of the hand and/or fingertips of the user to identify or translate user interactions with the virtual environment. The user interactions can include, for example and without limitation, moving an item of virtual content, resizing the item of virtual content and/or a location of the virtual private space, selecting an input interface element in a virtual user interface (e.g., a virtual representation of a mobile phone, a virtual keyboard, and/or other virtual interface), providing an input through a virtual user interface, etc.

The operations for the XR engine 120, the light estimation engine 122, the image processing engine 124, and the rendering engine 126 can be implemented by any of the compute components 110. In one illustrative example, the operations of the rendering engine 126 can be implemented by the GPU 114, and the operations of the XR engine 120, the light estimation engine 122, and the image processing engine 124 can be implemented by the CPU 112, the DSP 116, and/or the ISP 118. In some cases, the compute components 110 can include other electronic circuits or hardware, computer software, firmware, or any combination thereof, to perform any of the various operations described herein.

In some examples, the XR engine 120 can perform XR operations to generate an XR experience based on data from the image sensor 102, the accelerometer 104, the gyroscope 106, and/or one or more sensors on the light estimation system 100, such as one or more IMUs, radars, etc. In some examples, the XR engine 120 can perform tracking, localization, pose estimation, mapping, content anchoring operations and/or any other XR operations/functionalities. An XR experience can include use of the light estimation system 100 to present XR content (e.g., virtual reality content, augmented reality content, mixed reality content, etc.) to a user during a virtual session. In some examples, the XR content and experience can be provided by the light estimation system 100 through an XR application (e.g., executed or implemented by the XR engine 120) that provides a specific XR experience such as, for example, an XR gaming experience, an XR classroom experience, an XR shopping experience, an XR entertainment experience, an XR activity (e.g., an operation, a troubleshooting activity, etc.), among others. During the XR experience, the user can view and/or interact with virtual content using the light estimation system 100. In some cases, the user can view and/or interact with the virtual content while also being able to view and/or interact with the physical environment around the user, allowing the user to have an immersive experience between the physical environment and virtual content mixed or integrated with the physical environment.

The light estimation engine 122 can perform various light estimation operations associated with image data captured by the image sensor 102 (or other image sensors of the light estimation system 100). In some cases, light estimation can include determining characteristics of one or more light sources that illuminate a scene. Examples of light sources include, without limitation, overhead lights, lamps, candles, flashlights, displays (e.g., computer monitors, televisions, etc.), reflective surfaces (e.g., mirrors), and windows that transmit sunlight or light from other external sources, among other light sources. In some examples, the characteristics of a light source can be referred to as “lighting parameters” or “lighting cues.” The light estimation system 100 can use lighting parameters associated with a scene to facilitate immersive blending of virtual content with real-world content (e.g., real-world content visible to a user through an XR display of the light estimation system 100). For instance, the XR engine 120 can adjust visual characteristics of virtual objects (such as the color, shadows, shading, reflections, and/or specular highlights of the virtual objects) to ensure the virtual objects are visually coherent with respect to light sources illuminating the real-world objects. In some cases, the XR engine 120 can adjust visual characteristics of virtual objects by selecting (and implementing) one or more rendering models based on lighting parameters determined for a scene. When rendered within an XR display using the selected rendering model, the virtual objects may appear to be illuminated by the same light sources as the real-world objects. Further, the light estimation system 100 can utilize light estimation for applications not related to XR systems or similar systems. For instance, the light estimation system 100 can utilize light estimation to improve the quality of various image processing operations. In an illustrative example, the light estimation system 100 can use lighting parameters associated with a scene to implement a spatially varying auto-white balance algorithm (or other “3A” algorithm) within an image frame.

The light estimation engine 122 can determine any number or type of lighting parameters when performing light estimation. In one example, the light estimation engine 122 can determine the number and/or type of light sources illuminating a scene. The light estimation engine 122 can also determine a location of the light sources (e.g., the position, depth, and/or orientation of the light sources). Further, the light estimation engine 122 can determine ambient light qualities of a scene (e.g., fine and/or coarse ambient light qualities). In one example, the light estimation engine 122 can represent fine ambient qualities of a scene using a high-dynamic-range (HDR) map. Further, the light estimation engine 122 can determine the light intensity and/or color temperature of light emitted by one or more light sources. In an illustrative example, light estimation engine 122 can determine (e.g., estimate) a wattage of a lightbulb. In another illustrative example, the light estimation engine 122 can determine that a lightbulb is a fluorescent lightbulb (e.g., instead of an incandescent lightbulb), or determine that the lightbulb is a “soft white” lightbulb (e.g., instead of a “warm white” or “bright white” lightbulb). In a further illustrative example, the light estimation engine 122 can determine that a light source is a spherical light source (e.g., instead of a point light source).

In some cases, the light estimation engine 122 can perform light estimation for individual frames. The light estimation engine 122 can also perform aggregate (e.g., cumulative) light estimation by combining lighting parameters associated with multiple frames.

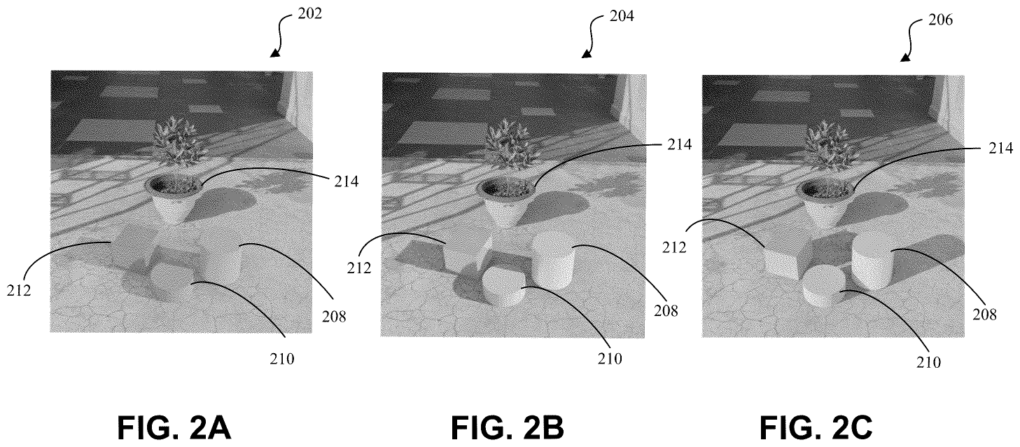

FIG. 2A, FIG. 2B, and FIG. 2C provide illustrations of an example light estimation process that may be performed by the light estimation system 100 (or any other light estimation system described herein). For instance, FIG. 2A shows a frame 202 that includes a physical object 214 (e.g., a potted plant) and virtual objects 208, 210, and 212 (e.g., blocks). The virtual objects 208, 210, and 212 represent examples of virtual content that can be generated and/or rendered by the light estimation system 100. In one example, the state (e.g., appearance) of the virtual objects 208, 210, and 212 in FIG. 2A can correspond to an initial state before the light estimation system 100 adjusts the visual appearance of the virtual objects 208, 210, and 212 based on lighting parameters associated with a scene. For instance, the virtual objects 208, 210, and 212 have been rendered using a standard and/or default rendering model. As shown, the visual appearance of the virtual objects 208, 210, and 212 has a poor correlation with the visual appearance of the physical object 214. For example, the direction and intensity of the shadows of the virtual objects 208, 210, and 212 do not match the direction and intensity of the shadow of the physical object 214. Further, the color casting and shading of the virtual objects 208, 210, and 212 do not correspond to the illumination of the scene (e.g., illumination by a high level of sunlight). FIG. 2B shows a frame 204 that includes the virtual objects 208, 210, and 212 after the light estimation system 100 adjusts the visual appearance of the virtual objects 208, 210, and 212 based on several lighting parameters of the light sources illuminating the scene. For example, the shadow intensity, color casting, and reflections associated with the virtual objects 208, 210, and 212 have been adjusted based on lighting parameters such as the power level and color of ambient light within the scene. As shown, the virtual objects 208, 210, and 212 in frame 204 appear to be more cohesive with respect to the physical object 214 than the virtual objects 208, 210, and 212 in frame 202. FIG. 2C shows a frame 206 representing additional improvements to the visual appearance of the virtual objects 208, 210, and 212. In this example, the visual appearance of the virtual objects 208, 210, and 212 has been adjusted to account for the direction of the main light source illuminating the scene. As shown, this update includes correcting the direction of the shadows of the virtual objects 208, 210, and 212. Overall, the virtual objects 208, 210, and 212 in frame 206 appear more photo-realistic than the virtual objects 208, 210, and 212 in frames 202 and 204.

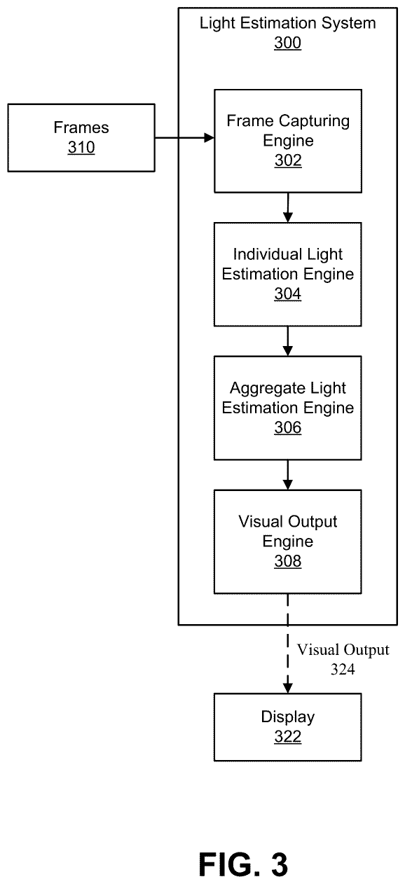

FIG. 3 is a block diagram illustrating an example of a light estimation system 300. In some cases, the light estimation system 300 can include and/or be part of the light estimation system 100 in FIG. 1. For instance, the light estimation system 300 can correspond to all or a portion of the light estimation engine 122. As shown in FIG. 3, the light estimation system 300 can include one or more engines, including a frame capturing engine 302, an individual light estimation engine 304, an aggregate light estimation engine 306, and a visual output engine 308. The engines of the light estimation system 300 can be configured to perform light estimation for one or more frames (e.g., frames 310) received by the frame capturing engine 302. The frames 310 can represent low-dynamic-range (LDR) frames, high-dynamic range (HDR) frames, standard-dynamic-range (SDR) frames, or any suitable type of frames. In some examples, the light estimation system 300 can determine a visual output 324 based at least in part on the light estimation performed for the one or more frames. In one example, the visual output 324 can include virtual content rendered within an XR display (e.g., a display 322). In another example, the visual output 324 can include one or more image processing operations or algorithms applied to image data of one of frames 310.

In some cases, the frame capturing engine 302 can receive frames captured by an image sensor (e.g., image sensor 102) of the light estimation system 300. For example, the frame capturing engine 302 can capture frames 310 while the light estimation system 300 is running an XR application. The individual light estimation engine 304 can perform individual light estimation on all or a portion of the frames 310. As used herein, “individual light estimation” can refer to the process of determining lighting parameters based on image data within an individual (e.g., a single) image frame. Individual light estimation for an individual frame may not include and/or depend on light estimation associated with any other frames.

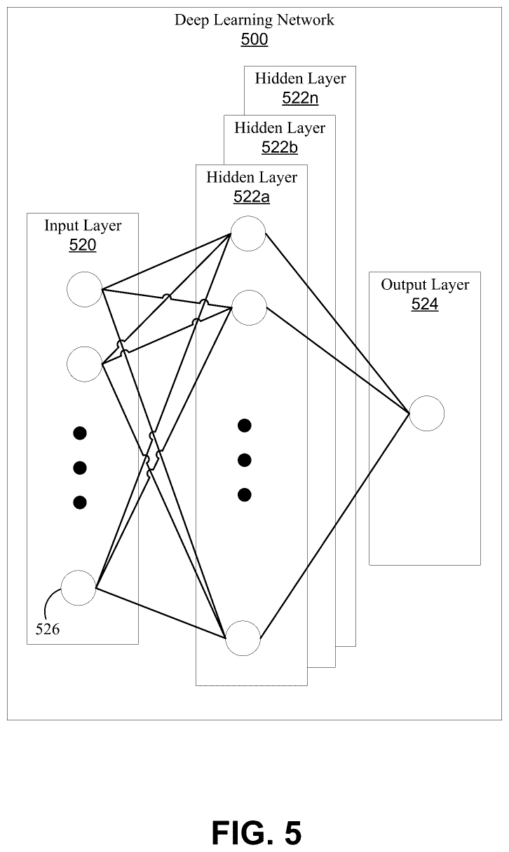

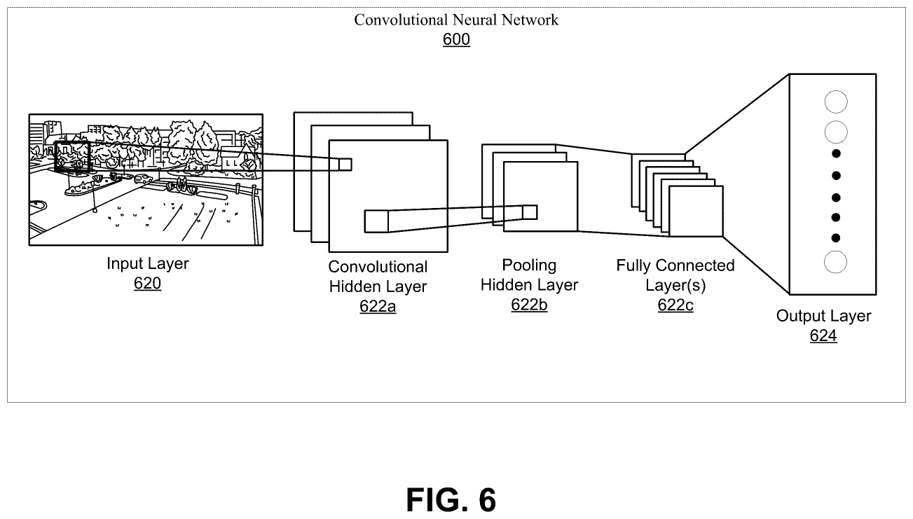

The individual light estimation engine 304 can perform individual light estimation in various ways. In some cases, the individual light estimation engine 304 can implement one or more machine learning system and/or algorithms configured to perform individual light estimation. For example, the individual light estimation process can be based on a machine learning model trained using a machine learning algorithm on images of scenes associated with various lighting parameters. In this example, the machine learning model can be trained to output lighting parameters associated with a frame when the frame is input to the model during inference. In an illustrative example, the machine learning model can be a deep neural network (NN), such as a convolutional neural network (CNN). Illustrative examples of deep neural networks are described below with respect to FIG. 5 and FIG. 6. In an illustrative example, the deep neural network can be a CNN configured to have an encoder-decoder architecture. Additional examples of the machine learning model include, without limitation, a time delay neural network (TDNN), a deep feed forward neural network (DFFNN), a recurrent neural network (RNN), an auto encoder (AE), a variation AE (VAE), a denoising AE (DAE), a sparse AE (SAE), a markov chain (MC), a perceptron, or some combination thereof. The machine learning algorithm may be a supervised learning algorithm, an unsupervised learning algorithm, a semi-supervised learning algorithm, a generative adversarial network (GAN) based learning algorithm, any combination thereof, or other learning techniques.

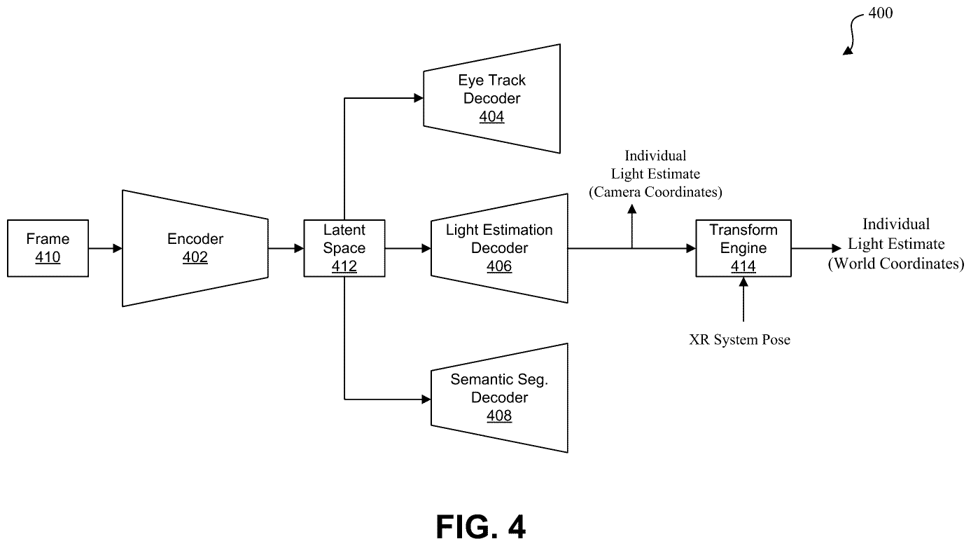

FIG. 4 is a block diagram illustrating an example of an individual light estimation system 400. In some cases, all or a portion of the individual light estimation system 400 can correspond to and/or be implemented by the individual light estimation engine 304 of the light estimation system 300. As shown, the individual light estimation system 400 can include an encoder 402. In some cases, the encoder 402 can represent an encoder of a deep neural network that has an encoder-decoder architecture. In some cases, the encoder 402 can be configured to receive a frame 410 (e.g., corresponding to one of frames 310 in FIG. 3). The encoder 402 can project image data of the frame 410 into a latent space 412 for in order to determine lighting parameters associated with the frame 410. For instance, the encoder 402 can be trained to determine one or more latent feature vectors based on image data projected into the latent space 412. In one example, the encoder 402 can be trained to determine one or more latent feature vectors for each distinct light source associated with a frame. The latent feature vectors can be hidden features that are not directly observed and/or perceived outside of the neural network. In some cases, the encoder 402 can represent a task-specific encoder configured for and/or dedicated to individual light estimation. In other examples, the encoder 402 can represent a common encoder configured to perform various machine learning tasks. For instance, the encoder 402 can be trained to determine a common set of latent feature vectors for multiple tasks such as light estimation, eye tracking, semantic segmentation, and saliency mapping, among others. In this way, the encoder 402 can utilize inference computations performed on the frame 410 for multiple tasks.

In some cases, the individual light estimation system 400 can include a light estimation decoder 406 trained to estimate lighting parameters based on the latent feature vectors determined by the encoder 402. In some cases, the lighting parameters can correspond to and/or be represented by estimated feature vectors. For instance, the light estimation decoder 406 can generate an estimated feature vector corresponding to each distinct light source within the scene. In some cases, the dimension of an estimated feature vector can correspond to the number of lighting parameters represented by the estimated feature vector. In an illustrative example, an estimated feature vector can be four-dimensional, with each dimension representing one of the location, depth, light color, and light intensity associated with a light source. In one example, the light estimation decoder 406 can represent a task-specific decoder configured for and/or dedicated to individual light estimation. As shown in FIG. 4, the individual light estimation system 400 can include one or more additional task-specific decoders, such as an eye track decoder 404 and/or a semantic segmentation decoder 408. However, the individual light estimation system 400 need not include any additional task-specific decoders or general-purpose decoders.

The light estimation decoder 406 can output an individual light estimate associated with the frame 410. As shown, the individual light estimate output by the light estimation decoder 406 can correspond to coordinates of a camera system (e.g., an image sensor) of the individual light estimation system 400. For example, the light estimation decoder 406 can represent the location of a light source with location information (e.g., 3D coordinates, depth values, etc.) relative to the camera system. In some cases, a transform engine 414 of the individual light estimation system 400 can transform the location information (e.g., estimated lighting parameters) output by the light estimation decoder 406 into real-world coordinates. For example, the transform engine 414 can determine 3D locations within the real-world environment corresponding to light sources detected by the light estimation decoder 406. In one example, the transform engine 414 can determine the 3D locations based on a 3D reconstruction of the scene and a current pose (e.g., location, orientation, and/or angle) of the camera system of the individual light estimation system 400. The transform engine 414 can determine the 3D reconstruction and/or the current pose of the camera system using various mapping, tracking, and/or localization techniques (e.g., 6DOF pose-tracking techniques).

FIG. 5 is an illustrative example of a deep learning neural network 500 that can be used by a light estimator. An input layer 520 includes input data. In one illustrative example, the input layer 520 can include data representing the pixels of an input frame. The neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. The neural network 500 further includes an output layer 524 that provides an output resulting from the processing performed by the hidden layers 522a, 522b, through 522n. In one illustrative example, the output layer 524 can provide a light estimation associated light a frame. The light estimation can include estimated lighting parameters.

The neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the hidden layers 522a, 522b, through 522n can transform the information of each input node by applying activation functions to these information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 524, at which an output is provided. In some cases, while nodes (e.g., node 526) in the neural network 500 are shown as having multiple output lines, a node has a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 524. In an example in which the neural network 500 is used to identify objects in images, the neural network 500 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 500 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 500 is trained well enough so that the weights of the layers are accurately tuned.

For the example of identifying objects in images, the forward pass can include passing a training image through the neural network 500. The weights are initially randomized before the neural network 500 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 500, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 500 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 500 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 500 can include any suitable deep network. One example includes a convolutional neural network (CNN), which includes an input layer and an output layer, with multiple hidden layers between the input and out layers. An example of a CNN is described below with respect to FIG. 5. The hidden layers of a CNN include a series of convolutional, nonlinear, pooling (for downsampling), and fully connected layers. The neural network 500 can include any other deep network other than a CNN, such as an autoencoder, a deep belief nets (DBNs), a Recurrent Neural Networks (RNNs), among others.

FIG. 6 is an illustrative example of a convolutional neural network 600 (CNN 600). The input layer 620 of the CNN 600 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 622a, an optional non-linear activation layer, a pooling hidden layer 622b, and fully connected hidden layers 622c to get an output at the output layer 624. While only one of each hidden layer is shown in FIG. 6, one of ordinary skill will appreciate that multiple convolutional hidden layers, non-linear layers, pooling hidden layers, and/or fully connected layers can be included in the CNN 600. As previously described, the output can indicate a single class of an object or can include a probability of classes that best describe the object in the image.

The first layer of the CNN 600 is the convolutional hidden layer 622a. The convolutional hidden layer 622a analyzes the image data of the input layer 620. Each node of the convolutional hidden layer 622a is connected to a region of nodes (pixels) of the input image called a receptive field. The convolutional hidden layer 622a can be considered as one or more filters (each filter corresponding to a different activation or feature map), with each convolutional iteration of a filter being a node or neuron of the convolutional hidden layer 622a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 622a. Each connection between a node and a receptive field for that node learns a weight and, in some cases, an overall bias such that each node learns to analyze its particular local receptive field in the input image. Each node of the hidden layer 622a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 622a is due to each node of the convolutional layer being applied to its corresponding receptive field. For example, a filter of the convolutional hidden layer 622a can begin in the top-left corner of the input image array and can convolve around the input image. As noted above, each convolutional iteration of the filter can be considered a node or neuron of the convolutional hidden layer 622a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 622a. For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 622a.

The mapping from the input layer to the convolutional hidden layer 622a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 622a can include several activation maps in order to identify multiple features in an image. The example shown in FIG. 6 includes three activation maps. Using three activation maps, the convolutional hidden layer 622a can detect three different kinds of features, with each feature being detectable across the entire image.

In some examples, a non-linear hidden layer can be applied after the convolutional hidden layer 622a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the network 600 without affecting the receptive fields of the convolutional hidden layer 622a.

The pooling hidden layer 622b can be applied after the convolutional hidden layer 622a (and after the non-linear hidden layer when used). The pooling hidden layer 622b is used to simplify the information in the output from the convolutional hidden layer 622a. For example, the pooling hidden layer 622b can take each activation map output from the convolutional hidden layer 622a and generates a condensed activation map (or feature map) using a pooling function. Max-pooling is one example of a function performed by a pooling hidden layer. Other forms of pooling functions be used by the pooling hidden layer 622a, such as average pooling, L2-norm pooling, or other suitable pooling functions. A pooling function (e.g., a max-pooling filter, an L2-norm filter, or other suitable pooling filter) is applied to each activation map included in the convolutional hidden layer 622a. In the example shown in FIG. 6, three pooling filters are used for the three activation maps in the convolutional hidden layer 622a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 622a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 622a having a dimension of 24×24 nodes, the output from the pooling hidden layer 622b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 600.

The final layer of connections in the network is a fully-connected layer that connects every node from the pooling hidden layer 622b to every one of the output nodes in the output layer 624. Using the example above, the input layer includes 28×28 nodes encoding the pixel intensities of the input image, the convolutional hidden layer 622a includes 3×24×24 hidden feature nodes based on application of a 5×5 local receptive field (for the filters) to three activation maps, and the pooling layer 622b includes a layer of 3×12×12 hidden feature nodes based on application of max-pooling filter to 2×2 regions across each of the three feature maps. Extending this example, the output layer 624 can include ten output nodes. In such an example, every node of the 3×12×12 pooling hidden layer 622b is connected to every node of the output layer 624.

The fully connected layer 622c can obtain the output of the previous pooling layer 622b (which should represent the activation maps of high-level features) and determines the features that most correlate to a particular class. For example, the fully connected layer 622c layer can determine the high-level features that most strongly correlate to a particular class, and can include weights (nodes) for the high-level features. A product can be computed between the weights of the fully connected layer 622c and the pooling hidden layer 622b to obtain probabilities for the different classes. For example, if the CNN 600 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 624 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

As previously mentioned, light estimation may include determining lighting parameters of one or more light sources illuminating a scene. For example, light estimation may include determining the number, type, and/or location of the light sources. Further, light estimation may include determining the intensity, color temperature, and/or other ambient qualities of the light emitted by the light sources. In some examples, light estimation may be implemented within extended reality systems to provide immersive blending of virtual content with real-world content visible through an extended reality display, such as a head-mounted display. Light estimation may be useful in various other applications, for example applications that involve performing image processing operations or algorithms, such as auto-white balance algorithms, auto-exposure algorithms, auto-focus algorithms, among others.

Light estimation can be an important perception feature in XR applications, which may be used to render virtual objects realistically. Light estimation can estimate the lighting condition of a scene from input images, which can be used to simulate various lighting environments when rendering virtual objects. The estimated lighting parameters, such as the ambient light and the main light direction, can be used to render objects in a scene realistically and to add visual cues, such as shadows and glossy reflections, to make the virtual experience much more immersive. It can be desirable to learn the intensity and location of light sources in a self-supervised manner without the need of any human annotation of the light sources.

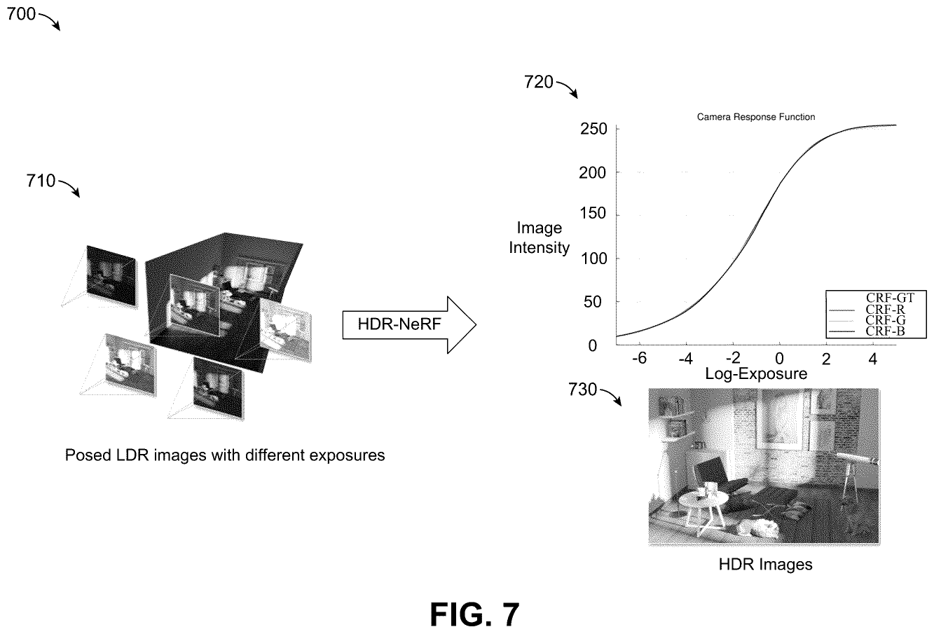

One main challenge in light estimation is to be able to predict the intensity of light sources from low dynamic range (LDR) images. FIG. 7 shows an example of a current process, the high dynamic range neural radiance fields (HDR-NeRF) method, for predicting the intensity of light sources from LDR images.

FIG. 7 is a diagram illustrating an example of a process 700 for neural light estimation (e.g., HDR-NeRF). In FIG. 7, for the process 700, a network (e.g., a neural network, such as a machine learning network) can be trained to learn high dynamic range (HDR) views (e.g., HDR images 730 with HDR intensities) and camera response functions (CRFs) from (e.g., based on) a sequence of LDR views (e.g. LDR images 710 with LDR intensities) with different exposure times and gains. After the training, the network can then recover HDR views (e.g., HDR images 730 with HDR intensities) and camera response functions (CRFs) from (e.g., based on) a sequence of LDR views (e.g. LDR images 710 with LDR intensities) with different exposure times and gains.

The CRF is a physical property of the camera, which is dependent upon the hardware of the camera. For a given camera, the CRF is fixed. For grayscale images, there will be only one CRF because the grayscale images only have one channel. For color images (e.g., RGB images), there will be three CRFs because color images have three channels (e.g., one channel for red, one channel for green, and one channel for blue). Graph 720 shows an example of four different CRFs, including a CRF associated with a ground truth (GT) CRF (denoted as CRF-GT), a CRF associated with a red (R) color channel (denoted as CRF-R), a CRF associated with a green (G) color channel (denoted as CRF-G), and a CRF associated with a blue (B) color channel (denoted as CRF-B). For graph 720, the x-axis denotes log-exposure, and the y-axis denotes image intensity.

For the process 700, after the HDR views (e.g., HDR images 730) are recovered, the intensity and location of an active light source(s) can be determined (e.g., estimated) from the resultant HDR views (e.g., HDR images 730). The process 700 can use self-supervised learning without the need for human annotation of the light sources.

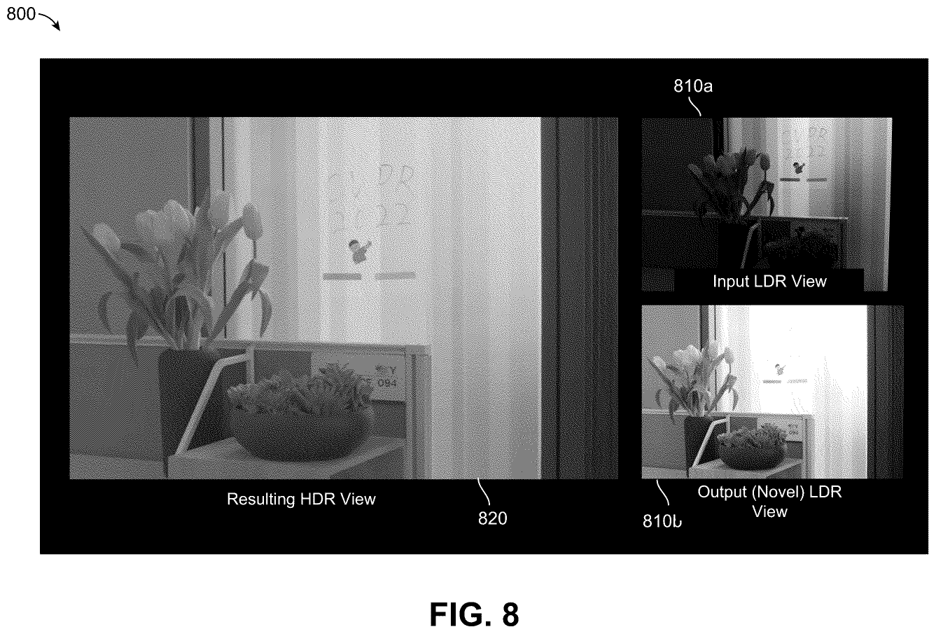

FIG. 8 is a diagram illustrating an example 800 of images for the process 700 for neural light estimation of FIG. 7. In FIG. 8, an example of an LDR view 810a that may be used as an input for the process 700 and an example output LDR view 810b are shown. An example of a resultant HDR view 820 that may be recovered by the process 700 is also shown.

Current state of-the-art methods, such as the HDR-NeRF method, have been shown to work well when using simple datasets. However, these methods have been observed to show divergent behavior depending on the initialization conditions when more complex datasets have been utilized, often resulting in degenerate solutions where the learned CRF can be incorrect, and the light sources cannot be identified. For instance, when random weight initialization is used for a model, bad initial weights can be obtained and divergent behavior can be observed.

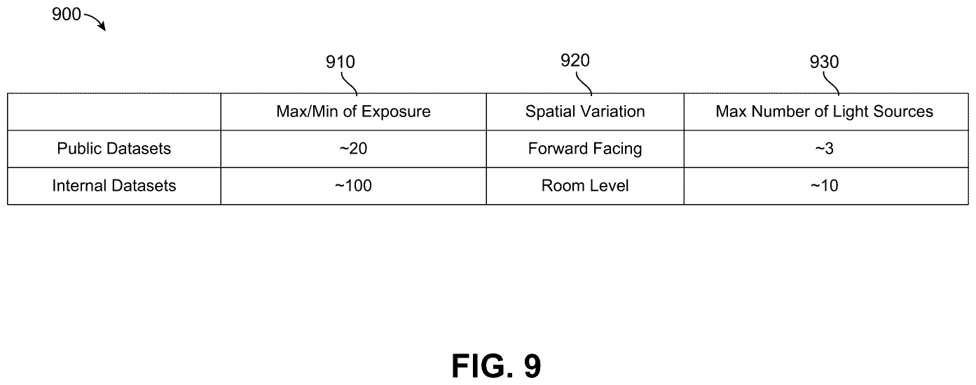

FIG. 9 shows a comparison between different example datasets. In particular, FIG. 9 is a table 900 illustrating an example of characteristics for different types of datasets. The table 900 shows a comparison between an example of a simple data set (e.g., a public dataset) and an example of a more complex dataset (e.g., an internal dataset). In FIG. 9, the table 900 is shown to have a maximum/minimum (max/min) of exposure 910 column, a spatial variation 920 column, and a maximum number of light sources 930 column. As shown in the table 900, the simple data set (e.g., a public dataset) has a max/min of exposure of approximately 20, while the more complex dataset (e.g., an internal dataset) has a much larger max/min of exposure of approximately 100. The table 900 also shows that the simple data set (e.g., a public dataset) has a maximum number of light sources of approximately three, while the more complex dataset (e.g., an internal dataset) has a much larger maximum number of light sources of approximately ten.

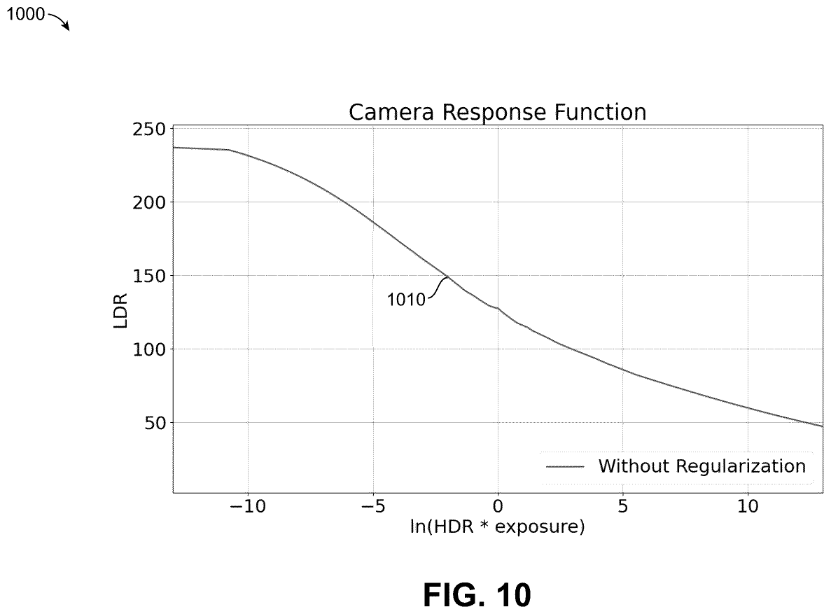

FIG. 10 is a graph 1000 illustrating an example of an incorrect CRF, which can result when current state of-the-art methods, such as the process 700 (e.g., the HDR-NeRF method), use complex datasets (e.g., the internal dataset of table 900). For the graph 1000, the x-axis denotes ln(HDR intensities*exposure), where ln denotes the natural log and exposure denotes the product of the exposure time and gain of an image frame, and the y-axis denotes the LDR intensities. As shown in the graph 1000, the CRF curve 1010 is shown to be decreasing. This CRF is incorrect because the CRF must be monotonically increasing to be correct.

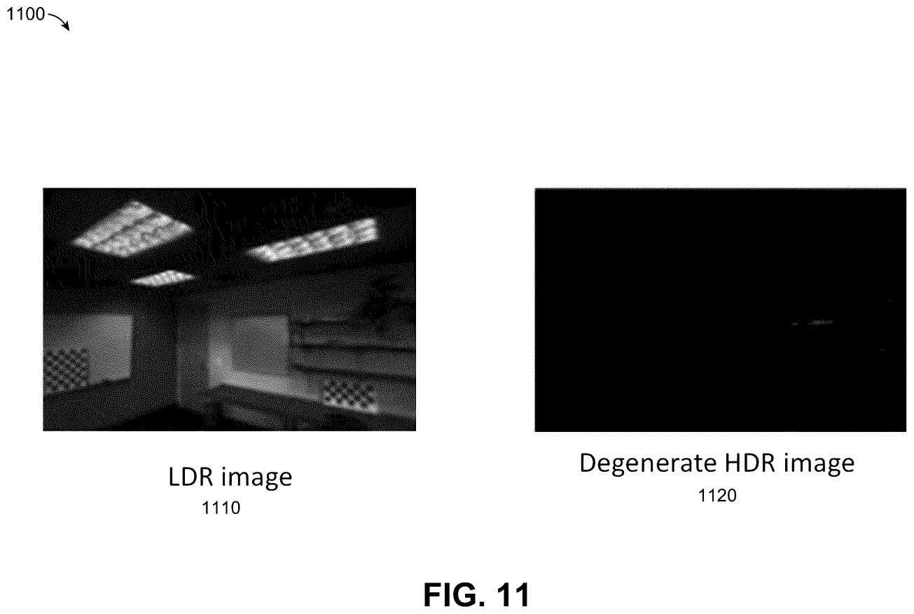

FIG. 11 is a diagram illustrating an example 1100 of a degenerate HDR image 1120, which can result when current state of-the-art methods, such as the process 700 (e.g., the HDR-NeRF method), use complex datasets (e.g., the internal dataset of table 900). In FIG. 11, an example of an LDR image 1110 that may be used as an input for the process 700 is shown. An example of a resultant degenerate HDR image 1120 that may be recovered by the process 700 is also shown. The degenerate HDR image 1120 is shown to have the failing of not including any of the light sources that are shown in the LDR image 1110. As such, improved systems and techniques that provide for robust light estimation, even when using complex datasets, can be useful.

In one or more aspects, the systems and techniques provide monotonic regularization for robust neural light estimation. In one or more examples, the systems and techniques can recover HDR information and the CRF (e.g., a correct CRF, which is monotonically increasing) from multi-view LDR images and, as a result, the light intensity values can be recovered successfully. The systems and techniques impose a monotonic physical prior to the CRF prediction of self-supervised light estimation methods. This is achieved by formulating the physical prior as a regularization loss (Lreg) during the training. With the regularization loss, the network (e.g., neural network) is encouraged to learn a monotonically increasing CRF. Based on this, a robust self-supervised light estimation system may be implemented. The regularization loss can enable robust and scalable neural light estimation, even for diverse and challenging datasets, and can also be generalized for use with different camera devices. Thus, the intensity and location of the light sources can be obtained from LDR images without the need for human annotations.

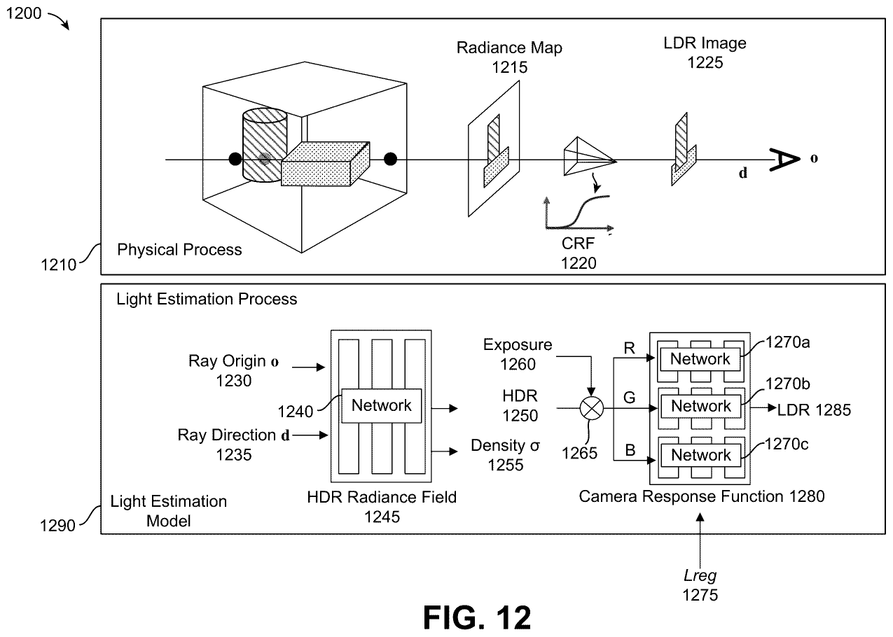

FIG. 12 is a diagram illustrating an example of a system 1200 for monotonic regularization for robust neural light estimation. The system 1200 of FIG. 12 can perform a pipeline of a light estimation process 1290 that models a simplified physical process 1210 of mapping radiance (e.g., as shown in the radiance map 1215) in a scene to pixel values in an image (e.g., an LDR image 1225) using a CRF 1220.

In one or more examples, for the light estimation model 1290, physical priors can be injected into a CRF prediction of neural HDR methods. In some examples, the physical prior may be that the CRF must be monotonically increasing. For the light estimation model 1290, a regularization loss (Lreg) can be applied to the CRF during training. In one or more examples, the predicted LDR intensity can be recovered by:

$$LDR = C ( ln ( HDR * exposure ) )$$

where C(x) can denote the network of the predicted CRF, HDR can denote the predicted HDR intensity, LDR can denote the predicted LDR intensity, and exposure can denote the product of the exposure time and gain of an image frame.

With the regularization loss (Lreg) applied during training, the network can be encouraged to learn a monotonically increasing CRF. In one or more examples, the regulation loss may be:

$$Lreg = \vert \frac{C ( x 2 ) - C ( x 1 )}{\vert C ( x 2 ) - C ( x 1 ) \vert} - 1 \vert , ∀ - k < x 1 < x 2 < k$$

where k can be a positive parameter, and x1 and x2 can be random values chosen for ln(HDR*exposure) for every iteration of the training, where x2 is greater than x1.

The light estimation model 1290 can include a plurality of networks 1240, 1270a, 1270b, 1270c. In one or more examples, each network 1240, 1270a, 1270b, 1270c may be in the form of a neural network, such as a machine learning network or a multi-layer perceptron (MLP), which may be termed as a neural radiance field (NeRF).

In one or more examples, during operation of the light estimation model 1290 for light estimation of a scene, a first network 1240 (e.g., an MLP) can determine first intensities (e.g., HDR intensities 1250) of the scene and a density (a) 1255, based on camera rays for an image of the scene. In some examples, a camera ray can include a ray origin (o) 1230 and a ray direction (d) 1235. In some examples, the first network 1240 (e.g., MLP) can include a radiance field model 1245. In one or more examples, the first network 1240 can be trained to learn the radiance field model 1245 by applying a plurality of multi-view images with second intensities (e.g., LDR intensities 1285). In one or more examples, the first intensities (e.g., HDR intensities 1250) can have a higher dynamic range than the second intensities (e.g., LDR intensities 1285).

In some examples, the first intensities (e.g., HDR intensities 1250) and an exposure 1260 can be multiplied together by a multiplexer 1265 to produce a product. The product can then be inputted into one or more second networks 1270a, 1270b, 1270c (e.g., MLPs), each including a CRF 1280. In one or more examples, the exposure 1260 can be a product of exposure time and gain of the image. The one or more second networks 1270a, 1270b, 1270c can determine the second intensities (e.g., LDR intensities 1285) of the scene based on the first intensities (e.g., HDR intensities 1250) of the scene and the exposure 1260. In one or more examples, the one or more second networks 1270a, 1270b, 1270c can be trained to learn their respective CRF 1280 by applying a regularization loss (Lreg) 1275. In some examples, as a result of the training of the one or more second networks 1270a, 1270b, 1270c, the regularization loss (Lreg) 1275 can force each CRF 1280 to be monotonically increasing.

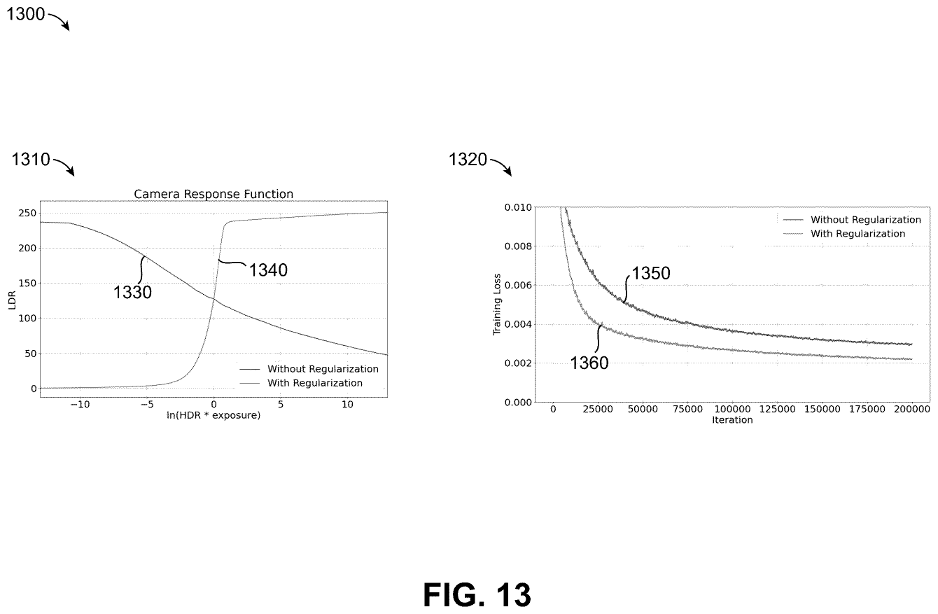

FIG. 13 is a diagram illustrating graphs 1310, 1320 showing examples 1300 of comparisons of camera response functions and training losses, respectively, when applying (and not applying) a regularization loss for neural light estimation. In FIG. 13, graph 1310 shows a comparison of a CRF (e.g., CRF curve 1330) from a light estimation model without regularization and a CRF (e.g., CRF curve 1340) from a light estimation model with regularization. For graph 1310, the x-axis denotes ln(HDR*exposure), and the y-axis denotes LDR intensities. As shown in the graph 1310, the CRF (e.g., CRF curve 1330) from a light estimation model without regularization is shown to be decreasing, which is indicative of an incorrect CRF. The CRF (e.g., CRF curve 1340) from a light estimation model with regularization is shown to be increasing, which can be indicative of a correct CRF.

In FIG. 13, graph 1320 shows a comparison of a training loss (e.g., training loss curve 1350) from a light estimation model without regularization and a training loss (e.g., training loss curve 1360) from a light estimation model with regularization. For graph 1320, the x-axis denotes iteration number, and the y-axis denotes training loss. As shown in the graph 1320, the training loss (e.g., training loss curve 1350) from a light estimation model without regularization is shown to greater (e.g., slower) than the training loss (e.g., training loss curve 1360) from a light estimation model with regularization.

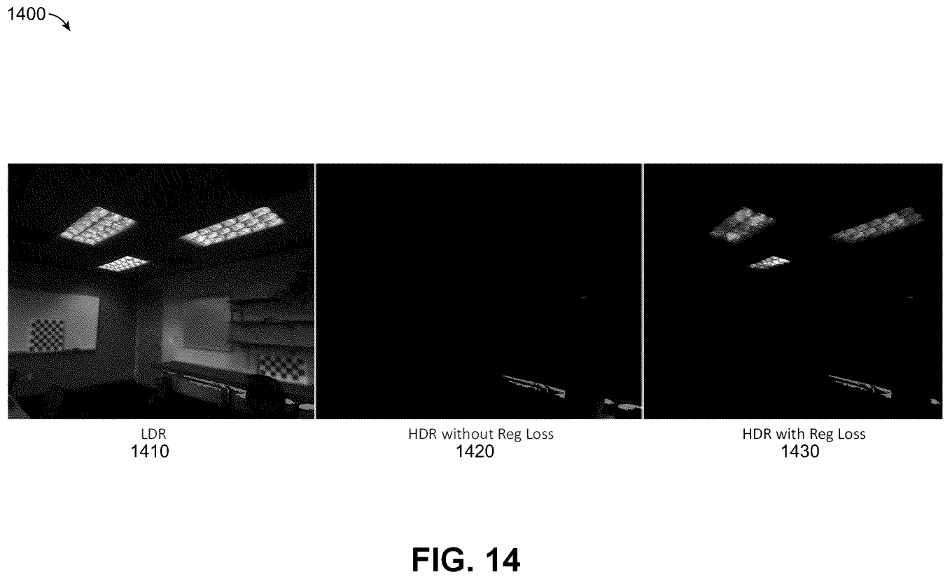

FIG. 14 is a diagram illustrating an example 1400 of a comparison of HDR images when applying (and not applying) a regularization loss for neural light estimation. In FIG. 14, an example of an LDR image 1410 that may be used as an input for a light estimation model (with and without a regularization loss) is shown. FIG. 14 shows an example of a resultant HDR image 1420 that may be recovered by a light estimation model without a regularization loss. The resultant HDR image 1420 is shown to have the failing of not including any of the light sources that are shown in the LDR image 1410. FIG. 14 also shows an example of a resultant HDR image 1430 that may be recovered by a light estimation model with a regularization loss. The resultant HDR image 1430 is shown to be successful in including the light sources shown in the LDR image 1410. As such, with the regularization loss, the model can predict the correct HDR images (e.g., HDR image 1430) and, thus, the intensity and the location of the light sources can be obtained.

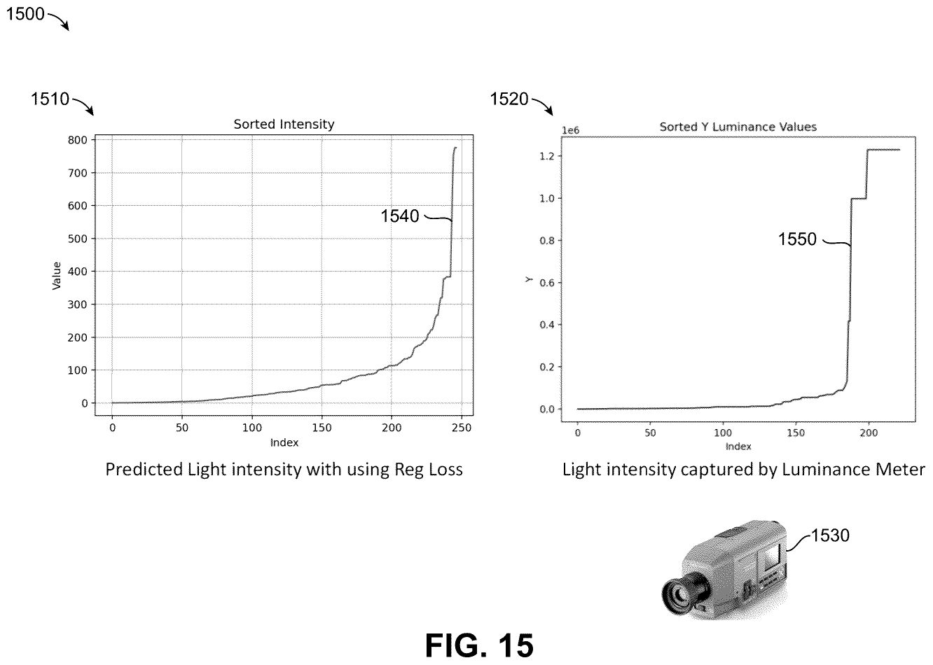

FIG. 15 is a diagram illustrating graphs 1510, 1520 showing an example 1500 of a comparison of predicted light intensities using neural light estimation with a regulation loss and measured light intensities measured by a luminance meter 1530. In FIG. 15, graph 1510 shows a distribution of predicted light intensities using a light estimation model with a regulation loss (e.g., predicted light intensities curve 1540) for 250 light sources. For graph 1510, the x-axis denotes index (e.g., an index for each light source), and the y-axis denotes a value for the light intensity. Graph 1520 shows a distribution of ground truth, measured light intensities measured by a luminance meter 1530 (e.g., measured light intensities curve 1550) for 250 light sources. For graph 1520, the x-axis denotes index (e.g., an index for each light source), and the y-axis denotes a value for the light intensity. By comparing the graphs 1510, 1520 (e.g., comparing the predicted light intensities curve 1540 with the ground truth, measured light intensities curve 1550), the distribution of predicted light intensities using a light estimation model with a regulation loss (e.g., predicted light intensities curve 1540) is shown to be very similar to the distribution of ground truth measured light intensities measured by a luminance meter 1530 (e.g., measured light intensities curve 1550) and, as such, the predicted light intensities using a light estimation model with a regulation loss (e.g., predicted light intensities curve 1540) appear to be correct.

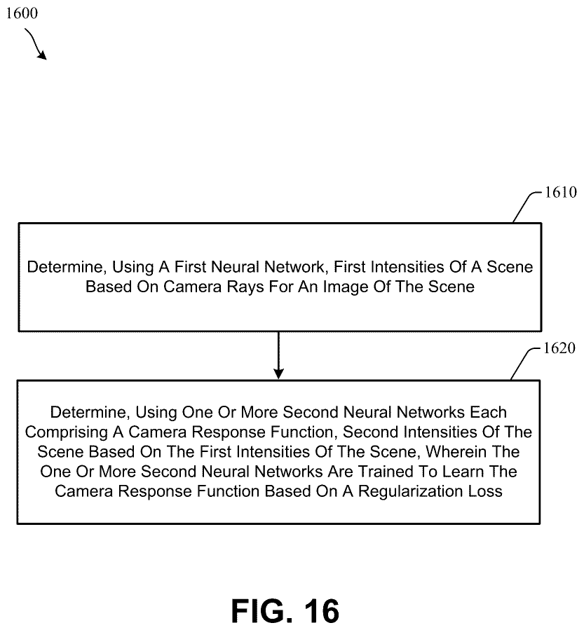

FIG. 16 is a flow chart illustrating an example of a process 1600 for monotonic regularization for robust neural light estimation. The process 1600 can be performed by a computing device (e.g., light estimation system 100 of FIG. 1, light estimation system 300 of FIG. 3, the system 1200 of FIG. 12, and/or a computing device or computing system 1700 of FIG. 17) or by a component or system (e.g., a chipset, one or more processors such as one or more central processing units (CPUs), digital signal processors (DSPs), graphics processing units (GPUs), any combination thereof, and/or other type of processor(s), or other component or system) of the computing device. The operations of the process 1600 may be implemented as software components that are executed and run on one or more processors (e.g., processor 1710 of FIG. 17 or other processor(s)). Further, the transmission and reception of signals by the computing device in the process 1600 may be enabled, for example, by one or more antennas and/or one or more transceivers (e.g., wireless transceiver(s)).

At block 1610, the computing device (or component thereof) can determine, using a first neural network (e.g., the first network 1240 of FIG. 12, which may be an MLP or other type of neural network), first intensities of the scene based on camera rays for an image of the scene. For instance, the first neural network is trained to learn a radiance field model based on a plurality of multi-view images with the second intensities. As described herein, a camera ray includes a ray origin (e.g., ray origin o 1230 of FIG. 12) and a ray direction (e.g., ray direction d 1235 of FIG. 12).

At block 1620, the computing device (or component thereof) can determine, using one or more second neural networks (e.g., one or more second networks 1270a, 1270b, 1270c of FIG. 12, which may each be a separate MLP), second intensities of the scene based on the first intensities of the scene. In some cases, the first intensities have a higher dynamic range than the second intensities. Each network of the one or more second networks each includes a camera response function (e.g., camera response function 1280 of FIG. 12). The one or more second neural networks are trained to learn the camera response function based on a regularization loss (e.g., the regulation loss L_{reg} 1275 of FIG. 12). As described herein, based on training the one or more second neural networks using the regularization loss, the camera response function is monotonically increasing.

In some cases, the computing device (or component thereof) can determine the second intensities using the one or more second neural networks further based on an exposure of the image. The exposure is a combination of an exposure time and a gain of a camera used to capture the image.

In some cases, the computing device of process 1600 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1600 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1600 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1600 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 17 is a block diagram illustrating an example of a computing system 1700, which may be employed for monotonic regularization for robust neural light estimation. In particular, FIG. 17 illustrates an example of computing system 1700, which can be for example any computing device making up internal computing system, a remote computing system, a camera, or any component thereof in which the components of the system are in communication with each other using connection 1705. Connection 1705 can be a physical connection using a bus, or a direct connection into processor 1710, such as in a chipset architecture. Connection 1705 can also be a virtual connection, networked connection, or logical connection.

In some aspects, computing system 1700 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1700 includes at least one processing unit (CPU or processor) 1710 and connection 1705 that communicatively couples various system components including system memory 1715, such as read-only memory (ROM) 1720 and random access memory (RAM) 1725 to processor 1710. Computing system 1700 can include a cache 1712 of high-speed memory connected directly with, in close proximity to, or integrated as part of processor 1710.

Processor 1710 can include any general purpose processor and a hardware service or software service, such as services 1732, 1734, and 1736 stored in storage device 1730, configured to control processor 1710 as well as a special-purpose processor where software instructions are incorporated into the actual processor design. Processor 1710 may essentially be a completely self-contained computing system, containing multiple cores or processors, a bus, memory controller, cache, etc. A multi-core processor may be symmetric or asymmetric.

To enable user interaction, computing system 1700 includes an input device 1745, which can represent any number of input mechanisms, such as a microphone for speech, a touch-sensitive screen for gesture or graphical input, keyboard, mouse, motion input, speech, etc. Computing system 1700 can also include output device 1735, which can be one or more of a number of output mechanisms. In some instances, multimodal systems can enable a user to provide multiple types of input/output to communicate with computing system 1700.

Computing system 1700 can include communications interface 1740, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1740 may also include one or more range sensors (e.g., LiDAR sensors, laser range finders, RF radars, ultrasonic sensors, and infrared (IR) sensors) configured to collect data and provide measurements to processor 1710, whereby processor 1710 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1740 may also include one or more Global Navigation Satellite System (GNSS) receivers or transceivers that are used to determine a location of the computing system 1700 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1730 can include software services, servers, services, etc., that when the code that defines such software is executed by the processor 1710, it causes the system to perform a function. In some aspects, a hardware service that performs a particular function can include the software component stored in a computer-readable medium in connection with the necessary hardware components, such as processor 1710, connection 1705, output device 1735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for light estimation of a scene, the apparatus comprising: at least one memory; and at least one processor coupled to the at least one memory and configured to: determine, using a first neural network, first intensities of the scene based on camera rays for an image of the scene; and determine, using one or more second neural networks each comprising a camera response function, second intensities of the scene based on the first intensities of the scene, wherein the one or more second neural networks are trained to learn the camera response function based on a regularization loss.

Aspect 2. The apparatus of Aspect 1, wherein, based on training the one or more second neural networks using the regularization loss, the camera response function is monotonically increasing.

Aspect 3. The apparatus of any of Aspects 1 or 2, wherein a camera ray comprises a ray origin and a ray direction.

Aspect 4. The apparatus of any of Aspects 1 to 3, wherein the first intensities have a higher dynamic range than the second intensities.

Aspect 5. The apparatus of any of Aspects 1 to 4, wherein the at least one processor is configured to determine the second intensities using the one or more second neural networks further based on an exposure of the image.

Aspect 6. The apparatus of Aspect 5, wherein the exposure is a combination of an exposure time and a gain of a camera used to capture the image.

Aspect 7. The apparatus of any of Aspects 1 to 6, wherein the first neural network is trained to learn a radiance field model based on a plurality of multi-view images with the second intensities.

Aspect 8. A method of light estimation of a scene, the method comprising: determining, using a first neural network, first intensities of the scene based on camera rays for an image of the scene; and determining, using one or more second neural networks each comprising a camera response function, second intensities of the scene based on the first intensities of the scene, wherein the one or more second neural networks are trained to learn the camera response function based on a regularization loss.

Aspect 9. The method of Aspect 8, wherein, based on training the one or more second neural networks using the regularization loss, the camera response function is monotonically increasing.

Aspect 10. The method of any of Aspects 8 or 9, wherein a camera ray comprises a ray origin and a ray direction.

Aspect 11. The method of any of Aspects 8 to 10, wherein the first intensities have a higher dynamic range than the second intensities.

Aspect 12. The method of any of Aspects 8 to 11, wherein the second intensities are determined using the one or more second neural networks further based on an exposure of the image.

Aspect 13. The method of Aspect 12, wherein the exposure is a combination of an exposure time and a gain of a camera used to capture the image.

Aspect 14. The method of any of Aspects 8 to 13, wherein the first neural network is trained to learn a radiance field model based on a plurality of multi-view images with the second intensities.

Aspect 15. A non-transitory computer-readable medium having stored thereon instructions that, when executed by at least one processor, cause the at least one processor to: determine, using a first neural network, first intensities of a scene based on camera rays for an image of the scene; and determine, using one or more second neural networks each comprising a camera response function, second intensities of the scene based on the first intensities of the scene, wherein the one or more second neural networks are trained to learn the camera response function based on a regularization loss.

Aspect 16. The non-transitory computer-readable medium of Aspect 15, wherein, based on training the one or more second neural networks using the regularization loss, the camera response function is monotonically increasing.

Aspect 17. The non-transitory computer-readable medium of any of Aspects 15 or 16, wherein a camera ray comprises a ray origin and a ray direction.

Aspect 18. The non-transitory computer-readable medium of any of Aspects 15 to 17, wherein the first intensities have a higher dynamic range than the second intensities.

Aspect 19. The non-transitory computer-readable medium of any of Aspects 15 to 18, wherein the instructions, when executed by the at least one processor, cause the at least one processor to determine the second intensities using the one or more second neural networks further based on an exposure of the image.

Aspect 20. The non-transitory computer-readable medium of Aspect 19, wherein the exposure is a combination of an exposure time and a gain of a camera used to capture the image.

Aspect 21. The non-transitory computer-readable medium of any of Aspects 15 to 20, wherein the first neural network is trained to learn a radiance field model based on a plurality of multi-view images with the second intensities.

Aspect 22. An apparatus for light estimation of a scene, the apparatus including one or more means for performing operations according to any of Aspects 8 to 14.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for light estimation of a scene, the apparatus comprising:
at least one memory; and
at least one processor coupled to the at least one memory and configured to:
determine, using a first neural network, first intensities of the scene based on camera rays for an image of the scene; and
determine, using one or more second neural networks each comprising a camera response function, second intensities of the scene based on the first intensities of the scene, wherein the one or more second neural networks are trained to learn the camera response function based on a regularization loss.

2. The apparatus of claim 1, wherein, based on training the one or more second neural networks using the regularization loss, the camera response function is monotonically increasing.

3. The apparatus of claim 1, wherein a camera ray comprises a ray origin and a ray direction.

4. The apparatus of claim 1, wherein the first intensities have a higher dynamic range than the second intensities.

5. The apparatus of claim 1, wherein the at least one processor is configured to determine the second intensities using the one or more second neural networks further based on an exposure of the image.

6. The apparatus of claim 5, wherein the exposure is a combination of an exposure time and a gain of a camera used to capture the image.

7. The apparatus of claim 1, wherein the first neural network is trained to learn a radiance field model based on a plurality of multi-view images with the second intensities.

8. A method of light estimation of a scene, the method comprising:
determining, using a first neural network, first intensities of the scene based on camera rays for an image of the scene; and
determining, using one or more second neural networks each comprising a camera response function, second intensities of the scene based on the first intensities of the scene, wherein the one or more second neural networks are trained to learn the camera response function based on a regularization loss.

9. The method of claim 8, wherein, based on training the one or more second neural networks using the regularization loss, the camera response function is monotonically increasing.

10. The method of claim 8, wherein a camera ray comprises a ray origin and a ray direction.

11. The method of claim 8, wherein the first intensities have a higher dynamic range than the second intensities.

12. The method of claim 8, wherein the second intensities are determined using the one or more second neural networks further based on an exposure of the image.

13. The method of claim 12, wherein the exposure is a combination of an exposure time and a gain of a camera used to capture the image.

14. The method of claim 8, wherein the first neural network is trained to learn a radiance field model based on a plurality of multi-view images with the second intensities.

15. A non-transitory computer-readable medium having stored thereon instructions that, when executed by at least one processor, cause the at least one processor to:
determine, using a first neural network, first intensities of a scene based on camera rays for an image of the scene; and
determine, using one or more second neural networks each comprising a camera response function, second intensities of the scene based on the first intensities of the scene, wherein the one or more second neural networks are trained to learn the camera response function based on a regularization loss.

16. The non-transitory computer-readable medium of claim 15, wherein, based on training the one or more second neural networks using the regularization loss, the camera response function is monotonically increasing.

17. The non-transitory computer-readable medium of claim 15, wherein a camera ray comprises a ray origin and a ray direction.

18. The non-transitory computer-readable medium of claim 15, wherein the first intensities have a higher dynamic range than the second intensities.

19. The non-transitory computer-readable medium of claim 15, wherein the instructions, when executed by the at least one processor, cause the at least one processor to determine the second intensities using the one or more second neural networks further based on an exposure of the image.

20. The non-transitory computer-readable medium of claim 15, wherein the first neural network is trained to learn a radiance field model based on a plurality of multi-view images with the second intensities.
